(19) United States
(12) Patent Application Publication
(10) Pub. No.: US 2011/0209603 A1
(43) Pub. Date: Sep. 1, 2011

(54) Machine Gun-Armed Aircraft Apparatus and Associated Methods

(75) Inventors: Mark D. Serkland, Lavon, TX (US); James A. Hardin, McKinney, TX (US); Steven S. Cone, Muenster, TX (US)

(73) Assignee: Contract Fabrication and Design, LLC, Princeton, TX (US)

(21) Appl. No.: 13/101,673

(22) Filed: May 5, 2011

Related U.S. Application Data
(62) Division of application No. 11/853,083, filed on Sep. 11, 2007.
(60) Provisional application No. 60/844,167, filed on Sep. 13, 2006.

(51) Int. Cl. B64D 7/00

(52) U.S. Cl. 89/9

(57) ABSTRACT

A single pintle arm-based structure is provided for mounting a machine gun on the exterior of a helicopter fuselage on the frame of or adjacent a gunner's cabin area side wall opening such as a window or door. The mounting structure permits horizontal pivotal motion of the single pintle arm and gun among lockable service, stowed, crew-served and full forward positions. The gun and the mounting structure, in their stowed position, are disposed externally of the helicopter, thereby permitting of the fuselage side wall opening, with the pintle arm being pivotable about an axis external to the fuselage.

### CROSS-REFERENCE TO RELATED APPLICATIONS

The present application is a division of copending U.S. patent application Ser. No. 11/853,083 filed Sep. 11, 2007 and claiming the benefit of the filing date of provisional U.S. patent application No. 60/844,167 filed Sep. 13, 2006. The entire disclosures of these two prior applications are incorporated herein by this reference.

### BACKGROUND OF THE INVENTION

The present invention generally relates to armament apparatus and, in a representatively illustrated embodiment thereof, more particularly provides a specially designed system for mounting a machine gun exteriorly adjacent a gunner's cabin area wall opening in a manner permitting the gun to be moved between and locked in a variety of orientations relative to the wall opening.

In military helicopters, machine guns are often mounted inside the cabin area inwardly adjacent a side wall opening (such as a door or window) in the helicopter fuselage so that the machine gun may be manually fired outwardly from the wall opening area. Conventionally configured mounting structures for these machine guns are typically subject to several problems, limitations and disadvantages. For example, to reposition the gun from its firing orientation to a stowed orientation within the cabin area it is necessary to lift the gun and upwardly pivot it about a horizontal axis of its underlying support structure into the cabin area. This procedure must subsequently be reversed to later reposition the gun in its firing orientation. Because of the weight and bulk of the gun, this tends to be an awkward and difficult task. Additionally, it can be hazardous to the gun operator if, during the vertical pivoting of the gun, the gun or its associated mounting structure falls on the operator or pinches his hand or other body part.

Moreover, with the gun in its stowed position within the cabin area, the gun and its associated mounting structure occupy considerable space within the cabin area—space that could be utilized for other purposes. Further, with the gun in its stowed position the gun may block the closing of the associated cabin door or window.

As can be readily seen from the foregoing, a need exists for an improved machine gun mounting structure which addresses these problems, limitations and disadvantages. It is to this need that the present invention is directed.

### SUMMARY OF THE INVENTION

In carrying out principles of the present invention, in accordance with a representatively illustrated embodiment thereof, armament apparatus is provided for arming an aircraft, representatively a helicopter, having a fuselage with a side wall opening that opens into a cabin area within the aircraft. Illustratively, an external frame extends around the fuselage side wall opening. In the illustrated representative embodiment thereof, the armament apparatus includes a base structure, representatively a mounting block, a single arm member having inner and outer end portions, and a machine gun.

The base structure is externally secured directly to the frame, or to a fuselage portion adjacent the frame, and a generally vertical first axis disposed outwardly of the fuselage extends through the base structure. The inner end of the single arm member is directly secured to the base structure so that the arm member longitudinally extends generally horizontally away from the base structure and is rotatable about the first axis in a manner permitting the arm member to pivot into and out of the fuselage opening. The machine gun is directly secured to the outer end portion of the single arm member, via a support portion, in a manner permitting the machine gun to be pivoted about a second axis extending generally parallel to the first axis, and also to be pivoted upwardly and downwardly. Locking structure is provided for releasably locking the machine gun in selectively variable orientations against rotation about the second axis, and for releasably locking the arm member in a selectively variable one of a plurality of rotational orientations relative to the base structure.

Preferably, the locking structure is operative to releasably lock the arm member in:
(1) a service position in which said single arm member is swung inwardly through the fuselage opening into the interior of the aircraft,
(2) a stowed position in which said single arm member longitudinally extends in a rearward direction from said base structure outwardly along the fuselage opening,
(3) a crew-served position in which said single arm member is swung somewhat outwardly from said stowed position thereof and forms an acute angle with a fuselage portion adjacent the fuselage opening, or
(4) a full forward position in which said single arm member projects generally transversely outwardly from a fuselage portion adjacent the fuselage opening.

The outer end of the machine gun barrel may be precluded from being swung into the cabin area by appropriately configuring the machine gun support portion in a manner limiting the permissible extent of upward and downward pivotal motion of the gun.

### BRIEF DESCRIPTION OF THE DRAWINGS

FIG. 1 is a simplified perspective view of a representative machine gun adjustably positioned at the gunner's cabin door area of a helicopter by a specially designed gun mounting structure embodying principles of the present invention, the machine gun being in a service position thereof;

FIG. 2 is a view similar to that in FIG. 1, but with the gun being having been moved to a stowed position thereof;

FIG. 3 is a view similar to that in FIG. 1, but with the gun having been moved to a crew-served position thereof; and

FIG. 4 is a view similar to that in FIG. 1, but with the gun having been moved to a full forward position thereof.

### DETAILED DESCRIPTION

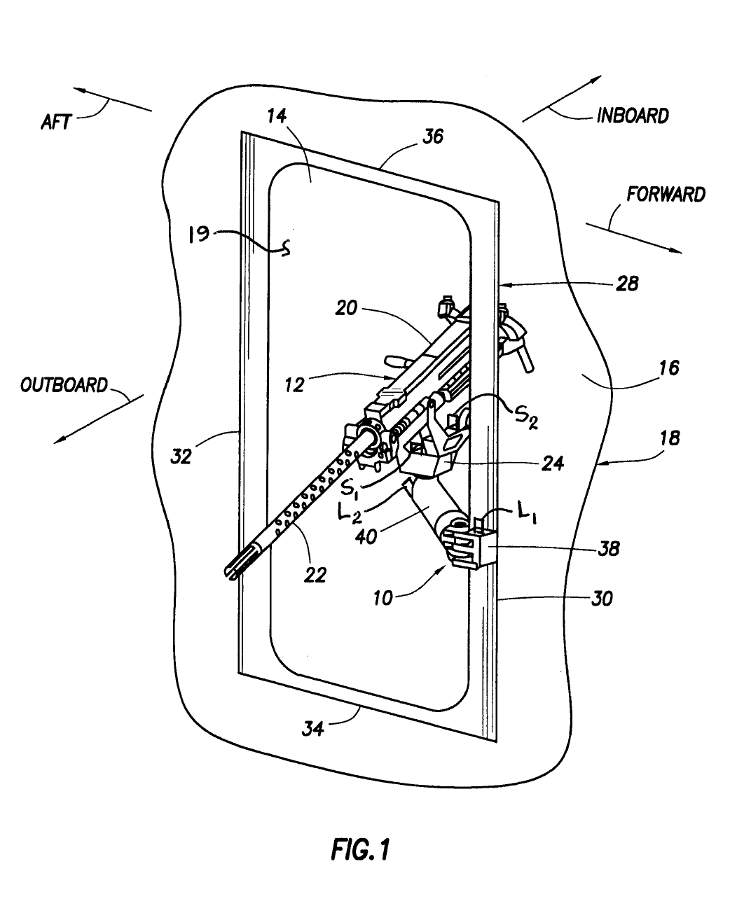

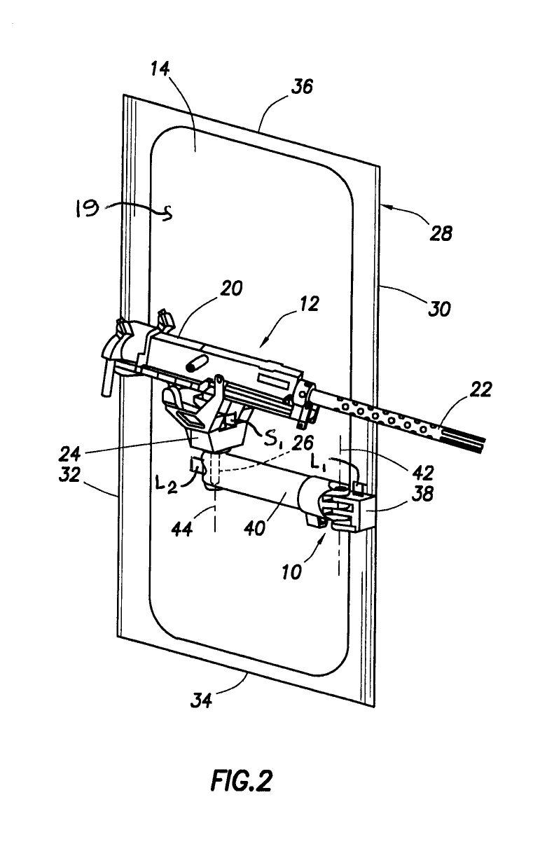

As shown in the accompanying FIGS. 1-4, this invention provides specially designed apparatus 10 for adjustably mounting a machine gun 12 at or closely adjacent a gunner's exterior wall opening 14 (such as, for example, a window or door opening) extending exteriorly along the fuselage 16 of a helicopter 18 (or other type of aircraft) and opening into a cabin area 19 of the helicopter 18. The machine gun 12 has a breech portion 20, a barrel portion 22, and a support portion 24 extending downwardly from the bottom side of the breech 20. A pintle post 26 (shown in phantom in FIG. 2) extends downwardly from the bottom side of the support portion 24. The opening 14 is bordered by a vertically elongated rectangular frame structure 28 having forward and aft vertical side portions 30 and 32, a sill portion 34, and an upper end portion 36.

The mounting apparatus 10 includes a mounting block 38, and an elongated, generally horizontally oriented single cylindrical pintle arm 40. Representatively, the mounting block 38 is externally secured to the forward frame side wall 30 and surrounds a vertical pivot axis 42 (see FIG. 2) disposed outboard of the fuselage 16 and the frame 28. Alternatively, the mounting block 38 could be secured to the outer side of the frame sill portion 34 adjacent the forward frame side wall 30, or on an exterior surface portion of the fuselage 16 adjacent the frame 28. The inner end of the pintle arm 40 (i.e., its right end as viewed in FIG. 2) is interlocked with the support block 38 for pivotal movement relative thereto about the axis 42.

A suitable schematically depicted locking structure L₁ is provided at the juncture between the pintle arm 40 and the support block 38 for releasably locking the pintle arm 40 in several pivotal orientations (subsequently described herein) relative to the stationary support block 38. Such releasable locking structure L₁ could, for example, be similar to the pin-and-hole type locking structure illustrated in FIGS. 7-12 in U.S. Pat. No. 6,293,179, the disclosure of which is hereby incorporated by reference herein in its entirety.

In such disclosure, a detent assembly 210 is operatively associated with the inner end of the support tube or pintle arm 134 for rotation therewith relative to an underlying locking ring/support structure 212 having a circumferentially spaced series of holes 252 formed therein. Pins having bodies 242 are carried by the detent assembly 210 for insertion into selectively variable ones of the holes 252 to correspondingly lock the pintle arm 134 in selectively variable rotational orientations relative to the support structure 212. A similar structure L₁ could be associated with the relatively rotatable inner end of the pintle arm 40 and the support block 38 in the present invention to lock the pintle arm 40 in selectively variable rotational orientations relative to the support block 38 in the present invention.

A vertically extending circular opening passing through the outer end of the pintle arm 40 rotatably receives the pintle post 26 to permit the machine gun 12 to be selectively rotated relative to the pintle arm 40 about the vertical axis 44 (see FIG. 2). A schematically depicted locking structure L₂ of a suitable conventional construction (such as that of locking structure L₁) is provided for locking the machine gun 12 in selectively variable rotational orientations relative to the pintle arm 40.

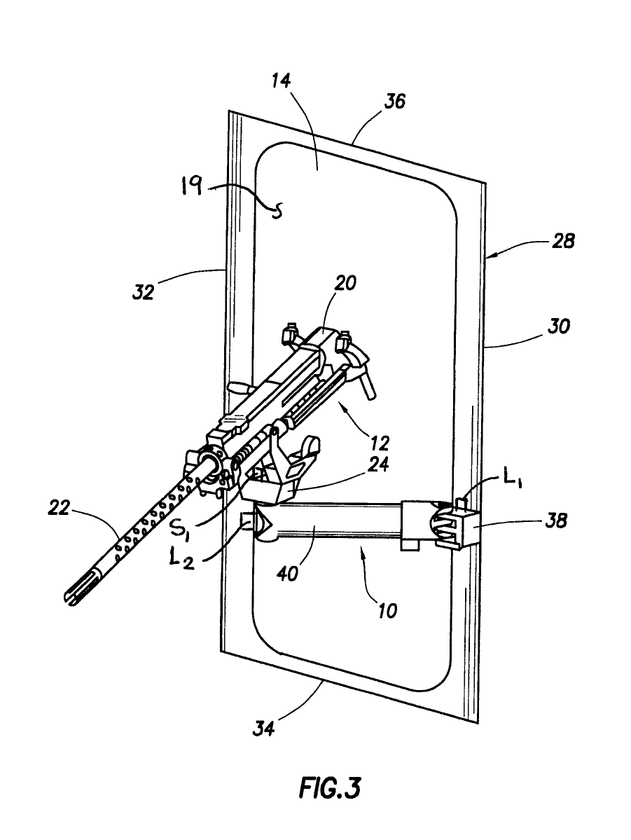

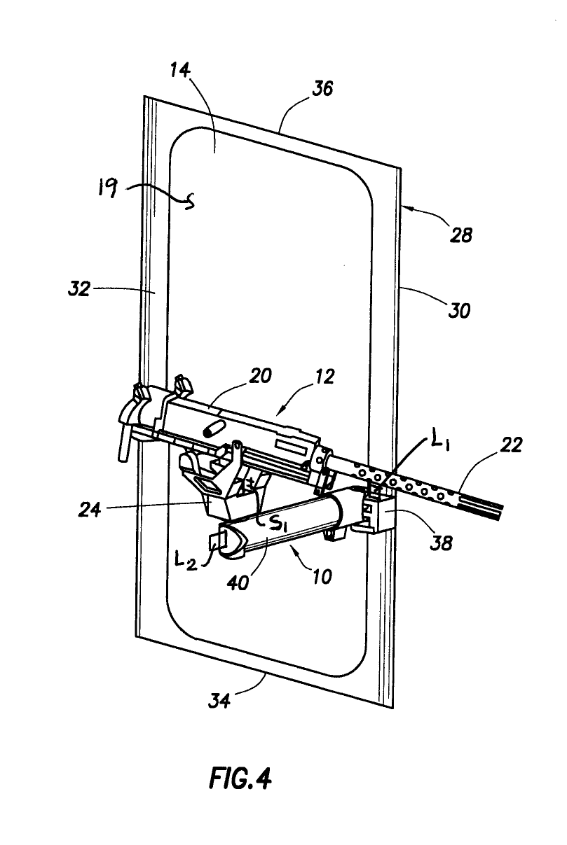

Using the pivotal mounting apparatus 10, the pintle arm 40, and the machine gun 12, may selectively be pivoted (about the vertical axes 42,44) among the following positions relative to the frame 28:
1. A service position (FIG. 1) in which the single pintle arm 40 and the machine gun receiver portion 20 are swung into the cabin area through the opening 14 to permit convenient in-cabin servicing of the gun;
2. A stowed position (FIG. 2) in which the single pintle arm 40 horizontally extends, in a rearward direction outwardly along the opening 14, with the gun 12 facing forwardly so that the wall opening 14 may be closed;
3. A crew served position (FIG. 3) in which the single pintle arm 40 is swung somewhat outwardly from its FIG. 2 stowed position and forms an acute angle with the outboard side of the frame 28, with the gun 12 pointing outwardly from the fuselage; and
4. A full forward position (FIG. 4) in which the single pintle arm 40 projects transversely outwardly from the frame 28, and the gun facing generally forwardly.

The pintle arm 40 may be rotationally locked, relative to the frame 28, in each of its four positions indicated in FIGS. 1-4, and the machine gun 12 may be locked relative to the pintle arm 40, in various rotational orientations with respect thereto, when desired.

Suitable means may be provided for preventing the outer end of the gun barrel 22 from being drawn inwardly through the opening 14 into the cabin so that the gun cannot be discharged within the cabin area. An example of such means, as would be readily apparent to one of skill in this particular art, is providing the machine gun 12 and its underlying support portion 24 with relative configurations that cooperate to limit the range of vertical pivotal motion of the gun in a manner preventing the outer end of the gun barrel from passing inwardly through the wall opening 14.

As can be seen, the mounting apparatus 10 of the present invention conveniently permits the gun 12 to be swung into and out of the cabin area via the wall opening 14 without having to lift the gun 12, and also permits the gun to be desirably stowed completely outside of the cabin area in a manner allowing the wall opening (such as a door or a window) to be closed during flight with the gun in its stowed position. For example, upwardly projecting pivot stops S₁ and S₂ could be placed on the upper side of supporting portion 24 to limit the upward and downward pivoting of the gun barrel relative to the supporting portion 24.

The foregoing detailed description is to be clearly understood as being given by way of illustration and example only, the spirit and scope of the present invention being limited solely by the appended claims.

What is claimed is:

1. Armed aircraft apparatus comprising:
an aircraft having a fuselage with a side wall opening extending inwardly therethrough and having a periphery;
a base structure exteriorly secured to said fuselage adjacent said opening periphery, a generally vertical first axis extending through said base structure outwardly of said periphery;
support apparatus having only a single generally horizontally extending arm member having an inner end portion directly secured to said base structure for rotation relative thereto about said first axis, and an outer end portion;
a machine gun directly mounted on said outer end portion of said single arm member, in an overlying relation therewith, for rotation relative thereto about a second axis parallel to said first axis; and
locking structure operative to releasably lock said single arm member in a selectively variable one of a plurality of rotational orientations relative to said base structure and releasably lock said machine gun in a selectively variable one of a plurality of rotational orientations relative to said outer end portion of said single arm member, including:
(1) a service position in which substantially the entire length of said single arm member and a breach portion of said machine gun are swung inwardly through said fuselage opening into the interior of said aircraft;
(2) a stowed position in which said single arm member longitudinally extends in a rearward direction from said base structure outwardly along said fuselage opening, with said machine gun forwardly extending generally parallel to the length of said single arm member;
(3) a crew-served position in which said single arm member is swung somewhat outwardly from said stowed position thereof and forms an acute angle with a fuselage portion adjacent the fuselage opening with said machine gun pointing in an outward direction; or and
(4) a full forward position in which said single arm member projects generally transversely outwardly from a fuselage portion adjacent the fuselage opening, with said machine gun being pointed in a generally forward direction.

2. The armed aircraft apparatus of claim 1 wherein:
said aircraft is a helicopter.

3. The armed aircraft apparatus of claim 2 wherein:
said opening opens inwardly to a cabin area of said helicopter.

4. The armed aircraft apparatus of claim 1 wherein:
said fuselage opening is surrounded by a frame, and
said base structure is externally secured to said frame.

5. The armed aircraft apparatus of claim 4 wherein:
said frame has a generally vertically extending front side portion, and
said base structure is externally secured to said front side portion of said frame.

6. The armed aircraft apparatus of claim 1 wherein:
said machine gun is pivotally mounted on a support structure secured to said outer end portion of said single arm member, and has a barrel with an outer end portion, and
said machine gun and said support structure are relatively configured to cooperate in a manner limiting pivotal motion of said machine gun to an extent precluding said outer end portion of said barrel from being swung inwardly through said fuselage side wall opening.

7. A method of arming an aircraft having a fuselage with a side wall opening therein which opens into the interior of the aircraft, said method comprising the steps of
providing only a single arm member having inner and outer end portions;
externally securing said inner end portion of said single arm member directly to the fuselage in a manner such that the length of said single arm member extends generally horizontally and said single arm member is pivotable relative to the fuselage, about a generally vertical first axis disposed outwardly thereof, into and out of the side wall opening;
rotatably mounting a machine gun directly on and in an overlying relationship with said outer end portion of said arm member; and
providing locking structure operative to releasably lock said single arm member in a selectively variable one of:
(1) a service position in which substantially the entire length of said single arm member and a breach portion of said machine gun are swung inwardly through said fuselage opening into the interior of said aircraft;
(2) a stowed position in which said single arm member longitudinally extends in a rearwardly direction from said base structure outwardly along said fuselage opening, with said machine gun forwardly extending generally parallel to the length of said single arm member;
(3) a crew-served position in which said single arm member is swung somewhat outwardly from said stowed position thereof and forms an acute angle with a fuselage portion adjacent the fuselage opening with said machine gun pointing in an outward direction; and
(4) a full forward position in which said single arm member projects generally transversely outwardly from a fuselage portion adjacent the fuselage opening, with said machine gun being pointed in a generally forward direction.

8. The method of claim 7 wherein:
the side wall opening has a frame extending around its periphery, and
said externally securing step is performed by externally securing said inner end portion of said arm member directly to said frame.

9. The method of claim 7 wherein:
said locking structure providing step is performed in a manner permitting said machine gun to be releasably locked, in a selectively variable one of a plurality of positions, against rotation relative to said outer end portion of said single arm member about a second axis generally parallel to said first axis.

10. The method of claim 7 wherein:
said machine gun has a barrel with an outer end portion,
said rotatably mounting step is performed by securing a support portion of the machine gun directly to said outer end of said single arm member in a manner permitting the machine gun to vertically pivot relative to said outer end of said single arm member, and
said method comprises the further step of relatively configuring said machine gun and said support portion so that they are cooperable in a manner limiting pivotal motion of said machine gun to an extent precluding said outer end portion of said barrel from being swung inwardly through said fuselage side wall opening.
